(19) United States
(12) Patent Application Publication
(10) Pub. No.: US 2004/0177648 A1
(43) Pub. Date: Sep. 16, 2004

(54) Glass material for molding, method of manufacturing same, and method of manufacturing glass articles using same

(75) Inventors: Takashi Igari, Iida-shi (JP); Shigeaki Ohmi, Tokorozawa-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HOYA CORPORATION, Tokyo (JP)

(21) Appl. No.: 10/623,560

(22) Filed: Jul. 22, 2003

(30) Foreign Application Priority Data
Aug. 2, 2002 (JP) 2002-225598

(51) Int. Cl. C03B 40/02

(52) U.S. Cl. 65/24; 65/60.3; 65/102

(57) ABSTRACT

A method of manufacturing a glass material for molding includes immersing a preformed glass material in an organic solution which contains an organic silicon-containing compound, an organic sulfur-containing compound, an organic fluorine-containing compound, or an organic nitrogen-containing compound to obtain the glass material which has a self-assembled film on a surface.

### TECHNICAL FIELD

The present invention relates to a glass material for molding having a self-assembled film or heat-produced film thereof on its surface, a method of manufacturing the same, and a method of manufacturing glass articles using the same.

### TECHNICAL BACKGROUND

Mold pressing is a method of conveniently molding precision optical glass materials with good productivity. In mold pressing, glass that has been melted and solidified or cold processed in advance into a glass material for molding of prescribed shape is placed in a pressing mold, softened by heating into a state permitting molding, and pressed. The molded glass is then cooled while still in the mold to obtain a glass element. Since a precisely processed mold is employed in this method, polishing of the glass material is unnecessary following molding.

When forming glass elements by mold pressing, the glass material for molding and mold are brought into close contact at a temperature above the softening point of the glass. Thus, a chemical reaction occurs at the interface of the glass and the mold, a portion of the glass fuses to the surface of the mold, fogging and clouding take place on the surface of the glass material, cracks and other fine defects are produced, and it is sometimes impossible to obtain a good glass lens.

In consideration of such problems in mold pressing, the technique of providing a mold separation film such as a thin carbon film, thin noble metal film, thin nitride film, or thin boride film on the surface of the mold to maintain the ability of the glass material to separate from the mold is known. However, optimum mold separation films have not yet been developed for all optical glass materials. In particular, when readily fusing glass is employed as the glass material, it is difficult to obtain adequate mold separation with existing mold separation films.

In particular, there are problems in that when employing a glass material containing volatile glass components such as halogens such as fluorine and oxides of alkali metals of Li, Na, and K in continuous pressing with a repeatedly employed mold, the glass fuses to the surface of the mold separation film with the volatile matter in the glass on the mold separation film surface serving as starting point; defects such as fogging, clouding, and cracking are produced; and it becomes impossible to obtain good glass lenses. The same problem is encountered even when employing glass materials comprising reductive components (Ti, Nb, W) tending to react with the molding surface.

In continuous pressing, pressing cannot be continued once fusing to the mold separation film of the mold has occurred. In such cases, it becomes necessary to completely remove the mold separation film of the mold, reveal the polished molding surface of the mold, and apply a new film. However, there are problems in that special conditions are required for the forming of mold separation films and considerable loss of time and cost is incurred.

The method of forming a film on the surface of the glass material has been proposed to resolve these problems.

Japanese Examined Patent Publication (KOKOKU) Heisei No. 2-31012 describes a method of preventing fusion by forming a carbon film on at least the surface of the glass material or the surface of the mold, both opposing each other.

Japanese Unexamined Patent Publication (KOKAI) Heisei No. 8-277125 discloses a method of forming a coating on the surface of the glass material by vacuum deposition or sputtering of a group IIIA metal oxide such as yttrium oxide or cerium oxide.

Japanese Unexamined Patent Publication (KOKAI) Heisei No. 11-236225 discloses a method of forming a coating on the surface of the glass material by vacuum deposition or sputtering of a sulfide or selenide of Mo, W, or Nb.

In the prevention of fusion by these methods, certain effects are achieved. However, elaborate equipment is required to form films on the surface of the glass material for molding, and it is difficult to effect controls to achieve films of uniform, suitable thickness. These methods do not necessarily effectively prevent fine fusion and remain unsatisfactory.

Japanese Unexamined Patent Publication (KOKAI) Heisei No. 10-167762 discloses a method of preventing fusion and fogging by coating a silane coupling agent on the surface of the glass material by spraying or spin coating. However, since the silane coupling agent is applied by these methods, the surface layer of the glass material for molding tends to be nonuniform and fine fusion is not necessarily prevented, so this method is unsatisfactory.

The present invention, devised in light of the above-described problems, has for its object to provide a glass material for molding that permits the formation of films of constant thickness and uniform surface layer conditions, does not require the use of elaborate equipment, and permits the prevention of fusion to the mold surface by a simple method such that optical elements with surfaces free of clouding, fogging, and cracking are obtained when the glass material is press molded even when the glass material is comprised of glass containing volatile glass components and highly reactive glass components.

A further object of the present invention is to provide a method of manufacturing glass articles such as optical elements with surfaces free of clouding, fogging, and cracking even from glass materials containing volatile glass components and highly reactive glass components.

### SUMMARY OF THE INVENTION

The present inventors focused on that the formation of a film satisfying the following four conditions on the surface of the glass material effectively prevented the fusion of the glass and mold surface and prevented clouding, fogging, and cracking of the surface of the glass elements obtained.

(1) A high coverage in coating of the glass material by the film;

(2) Ready control of the film thickness;

(3) Low reactivity of the film surface; and

(4) Low friction of the film surface.

That is, when the coverage in coating of the glass material by the film is insufficient, glass comes into direct contact with the mold surface in portions over which the film has not been formed, with the glass tending to fuse to the mold surface. Further, the film formed on the glass material is elongated by deformation of the glass during press molding. Thus, fusion occurs due to breaks in the film when the film is too thin, and clouding and fogging occur on the surface of the optical element when the film is too thick. Accordingly, precise control of film thickness is necessary within a given film lot and between film lots. Still further, when the reactivity of the film formed on the glass material is high, the surface of the mold is rendered rough by reactions occurring at the interface of the mold surface and the film during press molding. This roughness is transferred, resulting in clouding and roughness in the surface of the optical element obtained. Accordingly, the film formed on the glass material should be comprised of a substance of low reactivity. Still further, the tendency of the glass material to deform during press molding depends on friction between the film formed on the glass material and the surface of the mold. When there is little friction between the film and mold surface, the glass material deforms rapidly during press molding, reducing fusion and cracking. Accordingly, the film formed on the glass material should have a low-friction surface.

The present inventors discovered that self-assembled films satisfy these conditions, permit reliable film formation, afford good manufacturing properties, are inexpensive, and are extremely effective at solving the above-stated problems; the present invention was devised on this basis.

The present invention relates to a glass material for molding characterized by being a preformed glass material having a self-assembled film on the surface thereof.

In the glass material for molding of the present invention, it is desirable for:

(1) the free surface energy of the surface of the glass material on which the self assembled film is provided to be less than or equal to 60 mJ/m²;

(2) the self-assembled film to be comprised of an organic silicon-containing compound, organic sulfur-containing compound, organic fluorine-containing compound, or organic nitrogen-containing compound; and

(3) the self-assembled film to comprise at least one compound selected from among the group consisting of trialkyl silane compounds, dialkyl silane compounds, alkyl silane compounds, alkyl dimethyl silane compounds, alkane thiol compounds, dialkyl sulfide compounds, dialkyl disulfide compounds, and dimethyl ammonium compounds.

The present invention further relates to a method of manufacturing a glass material for molding characterized in that a preformed glass material is immersed in an organic solution comprising an organic silicon-containing compound, organic sulfur-containing compound, organic fluorine-containing compound, or organic nitrogen-containing compound to obtain a glass material having a self-assembled film.

In the manufacturing method of the present invention, it is desirable for:

(1) the molecule of the organic silicon-containing compound, organic sulfur-containing compound, organic fluorine-containing compound, or organic nitrogen-containing compound to comprise a —Cl group, —H group, or (S—S) group;

(2) the organic silicon-containing compound, organic sulfur-containing compound, organic fluorine-containing compound, or organic nitrogen-containing compound to be at least one member selected from the group consisting of chlorotrialkyl silane compounds, dichlorodialkyl silane compounds, trichloroalkyl silane compounds, alkyldimethyl (dimethylamino) silane compounds, alkanethiol compounds, dialkylsulfide compounds, dialkyldisulfide compounds, and dimethylammonium compounds; and

(3) the concentration of the organic compound to be 0.01 to 10 weight percent of the organic solution.

The present invention further relates to a method of manufacturing a glass material for molding characterized in that the glass material of the present invention or a glass material obtained by the above-described method of manufacturing of the present invention is heat treated in a non-oxidizing atmosphere to thermally decompose the self-assembled film on the glass material.

In the present method of manufacturing a glass material for molding of the present invention, it is desirable for:

(1) the heat treatment temperature to be greater than or equal to 200° C. and less than or equal to 800° C., and

(2) the free surface energy of the surface of the glass material obtained by the heat treatment to be less than or equal to 70 mJ/m².

The present invention further relates to a method of manufacturing glass articles comprising the heat softening of the above-described glass material of the present invention or a glass material obtained by the above-described manufacturing method of the present invention, and press molding with a pressing mold.

### BRIEF DESCRIPTION OF DRAWINGS

FIG. 1 is a descriptive drawing of a self-assembled film.

FIG. 2 is a descriptive drawing of a self-assembled film comprising multiple molecular layers.

FIG. 3 is a descriptive drawing of a glass material for molding having a self-assembled film on its outer layer.

FIG. 4 is a descriptive drawing of an optical element manufacturing process.

FIG. 5 shows the IR-RAS spectrum of the self-assembled film obtained in Example 1.

The following is a key to the symbols employed in the individual drawings.

1 Coating solution

2 Molecules in solution (O portion: functional group)

3 Base material to be coated with film

4 Self-assembled film

5 Molecule of self-assembled film

6 Multilayered self-assembled film

7 Self-assembled film comprised of multiple molecular layers

8 Molecule A of the self-assembled film

9 Molecule B of the self-assembled film

10 Molecule 1 of the self-assembled film

11 Molecule 2 of the self-assembled film

12 Molecule 3 of the self-assembled film

13 Molecule 4 of the self-assembled film

14 Preformed glass

15 Self-assembled film

### BEST MODE OF IMPLEMENTING THE INVENTION

The glass material for molding of the present invention is characterized by being a preformed glass material having a self-assembled film on its surface. Neither the shape nor dimensions of the preformed glass material are specifically limited.

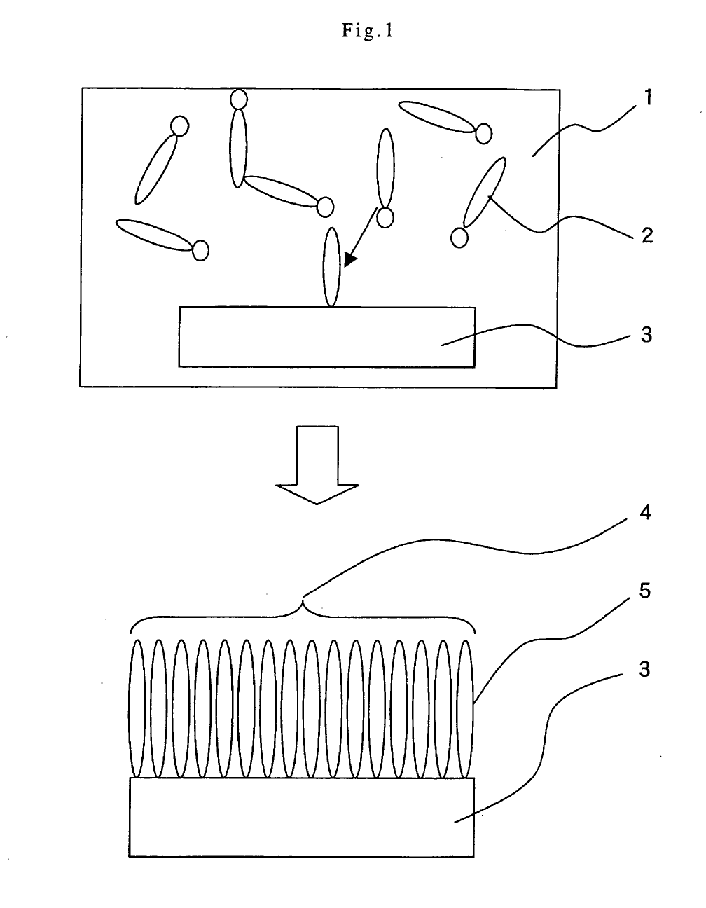

Self-assembled films are known in the literature; for example, see Hiroyuki SUGIMURA, Osamu TAKAI: Research Materials of the 199^{th} Meeting of the 131^{st} Committee on Thin Films of the Japan Society for the Promotion of Science, Feb. 1, 2000, pp. 34-39; and Seunghwan Lee, Young-Seok Shon, Ramon Colorado, Jr., Rebecca L. Guenard, T Randall Lee, and Scott S. Perry: Langmuir Vol. 16 (2000), pp. 2220-2224. As shown in FIG. 1, the functional groups (O portions) of molecules 2 in solution 1 automatically react with the surface of base material to be coated with film 3, automatically and spontaneously arranging and organizing themselves on the surface of base material to be coated with film 3 into the structure of film 4.

For example, in the self-assembled film of the present invention, a specific organic compound molecule is selected; a glass material is exposed to a solution containing a specified concentration of the organic compound molecule in an organic solvent, for example; and reaction conditions are created to form a single molecule organic film of oriented organic compound molecules. Since the film is formed by causing the organic compound molecules to react with the surface of the base material to be coated with film and assemble themselves, film formation is possible with an extremely high coverage. It is also possible to pretreat the glass surface to achieve efficient film formation. Examples of the organic compound molecule are organic silicon-containing compounds, organic sulfur-containing compounds, organic fluorine-containing compounds, and organic nitrogen-containing compounds of higher reactivities.

Examples of the functional groups in the organic compounds that are capable of automatically and spontaneously reacting with the surface of the base material to be coated with film (glass) are primarily —Cl groups in organic silicon-containing compounds (reaction equation (1) below), primarily —H and (S—S) groups in organic sulfur-containing compounds (reaction equations (2) and (3) below), and primarily —H groups in organic nitrogen-containing compounds (reaction equation (4) below).

For example, the following may be employed in the reaction of the functional group (O portion) of molecule 2 of solution 1 and the surface of base material to be coated with film 3. When there is a group having a chlorine atom in the organic compound, such as in chlorotrialkyl silane compounds, dichlorodialkyl silane compounds, and trichloroalkyl silane compounds, it becomes the reactive functional group. As shown in reaction equation (1), it reacts automatically and spontaneously with the —OH group of the surface of base material to be coated with film (glass) 3, HCl is eliminated, and a self-assembled film with the above-described compound as the starting material is formed on the surface of base material to be coated with film 3.

Reaction equation (1)

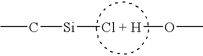

The above reaction takes place because a clean glass surface is highly reactive and reacts with water molecules in the air when the glass is exposed to the atmosphere, and thus it is covered with —OH groups on the entire surface thereof.

Further, in the case of alkanethiol compounds, for example, the H atom bonding to the S atom in the thiol group of the compound becomes the functional group, and as is shown in reaction equation (2), reacts automatically and spontaneously with the —OH group on the surface of base material to be coated with film 3. H₂ is eliminated and a self-assembled film is formed on the surface of base material to be coated with film 3 with the above-described compound as starting material.

Reaction equation (2):

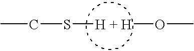

Further, in the case of dialkyldisulfide compounds, for example, the S—S bond in the compound becomes the functional group, and as is shown in reaction equation (3), reacts automatically and spontaneously with the —OH group on the surface of base material to be coated with film 3. H₂ is eliminated and a self-assembled film is formed on the surface of base material to be coated with film 3 with the above-described compound as starting material.

Reaction equation (3):

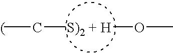

In the case of dimethylammonium compounds and alkyldimethyl (dimethylamino) silane compounds, the H atom bonded to the N atom in the compound serves as the functional group, and as shown in reaction equation (4), reacts automatically and spontaneously with the —Cl group on the surface of base material to be coated with film 3. HCl is eliminated and a self-assembled film is formed on the surface of base material to be coated with film 3 with the above-described compound as starting material.

Reaction equation (4):

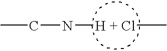

The above reaction takes place because the surface is covered with —Cl groups when the glass surface is exposed to a dry atmosphere containing chlorine.

As set forth above, it is necessary for a compound having a functional group automatically or spontaneously reacting with the —OH group or —Cl group of the surface of the base material to be coated with film to be brought into contact with the surface of the base material to be coated with film in a state in which the reactivity of the functional group is preserved to form a self-assembled film. For example, when an organic compound comprising a self-assembled film as starting material is placed in an atmosphere comprising substantial quantities of water or chlorine, the reactivity of the functional group tends to be lost. Accordingly, the organic compound is desirably stored in a state in which the reactivity of the functional group is maintained.

In the reaction to form a self-assembled film, it is desirable that the reaction rate is high. As stated for reaction equations (1) to (4), —Cl groups, —H groups, and (S—S) groups are desirable because of their high reaction rates. Further, when a starting material having a functional group with a low reaction rate such as an OR group (alkoxy group) is employed, the reaction shown in reaction equation (5) below takes place. However, this reaction progresses slowly and the film formation rate is correspondingly low.

Reaction equation (5)

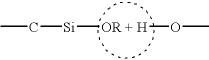

Further, although the organic compound molecule employed as the starting material of the self-assembled film in the present invention has the above-described functional group at a terminal position, it may have an alkyl group, aryl group, vinyl group, epoxy group, or fluorine atom on the other terminal (the surface terminal side when the above-described functional group serves as the bonding terminal). An alkyl group or aryl group is preferred. When such a group is present, it is possible to maintain low surface energy, as will be described further below; fusion, cracking, and fogging are inhibited; and good press molding can be achieved.

The following are examples of compounds that may be employed as the reactive organic silicon-containing compounds, organic sulfur-containing compounds, organic fluorine-containing compounds, and organic nitrogen-containing compounds employed as the starting materials of the self-assembled film. However, such compounds are not limited to this list; any compound capable of forming a self-assembled film on the glass material may be employed.

Examples of chlorotrialkyl silane compounds are: chlorotrimethyl silane, chlorotriethyl silane, pentafluorophenyl dimethylchlorosilane, tert-butyldimethyl chlorosilane, (3-cyanopropyl)dimethyl chlorosilane, chlorotrifluoromethyl silane, and derivatives thereof. Examples of dichlorodialkyl silane compounds are dichlorodimethyl silane, dichloromethylvinyl silane, dichlorodifluoromethyl silane, dichloro-n-octadecylmethyl silane, n-octylmethyl dichlorosilane, dichlorocylcohexylmethyl silane, and derivatives thereof. Examples of trichloroalkyl silane compounds are trichlorovinyl silane, n-octadecyl trichlorosilane, isobutyl trichlorosilane, n-octafluorodecyl trichlorosilane, cyanohexyl trichlorosilane, and derivatives thereof. An example of a trichloroaryl silane compound is phenyl trichlorosilane. Examples of alkyldimethyl(dimethylamido) silane compounds are trimethyl(dimethylamide) silane, triethyl(dimethylamido) silane, pentafluorophenyldimethyl(dimethylamido) silane, trifluoromethyl(dimethylamido)silane, tert-butyldimethyl(dimethylamido)silane, (3-cyanopropyl)dimethyl)dimethylamido)silane, and derivatives thereof. Examples of alkanethiol compounds are 1-butanethiol, 1-decanethiol, 1-fluorodecanethiol, o-aminothiophenol, 2-methyl-2-propanethiol, n-octadecanethiol, and derivatives thereof. Examples of dialkylsulfide compounds are ethyl methyl sulfide, dipropyl sulfide, n-hexyl sulfide, fluoroethylmethyl sulfide, phenylvinyl sulfide, derivatives thereof, ethyl phenyl sulfides, and derivatives thereof. Examples of dialkyldisulfide compounds are ptolyldisulfide, diallyldisulfide, methylpropyldisulfide, fluoromethylpropyldisulfide, difurfuryldisulfide, derivatives thereof, methylphenyldisulfide, and derivatives thereof. Examples of dimethylammonium compounds are dihexadecyldimethylammonium acetate, dioctadecyldimethylammonium acetate, dieicosyldimethylammonium bromide, dimethyldioctadecylammonium iodide, dioctafluorodecyldimethylammonium acetate, dimethyldioleylammonium iodide, and derivatives thereof.

The self-assembled film of the present invention can be formed by immersing preformed glass in an organic solution (referred to hereinafter as a “coating solution”) in which the above-described organic compound molecules serving as the starting materials for the self-assembled film have been dissolved. The solvent employed in the organic solution is desirably an anhydrous organic solvent. This is to avoid causing the organic compound molecules in the starting materials to lose their reactivity due to reaction with water molecules. When a solvent having polarity is employed, bonds are also similarly formed with the organic compound molecules, causing the organic compound molecules to lose their reactivity. Thus, a nonpolar solvent is desirably selected. That is, the solvent employed is desirably selected from among solvents maintaining the reactivity of the functional groups of the organic compound molecules.

Specific examples of preferred solvents are anhydrous nonpolar organic solvents such as hexane, anhydrous organic solvents such as toluene, chloroform, and mixtures of these solvents.

When diluting the starting compounds of the self-assembled film with organic solvents having polarity such as alcohols, the functional group sometimes reacts with the —OH group in the alcohol, as shown in reaction equation (6) below, causing the functional group to be lost and causing the —OH group of the surface of the base material to be coated with film to tend not to react with a —Cl group. Thus, the organic solvent desirably does not contain an —OH group.

Reaction equation (6)

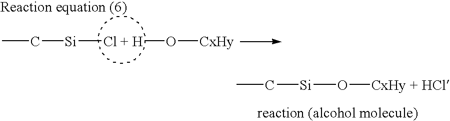

The concentration of the starting materials in the above coating solution desirably falls within the range of from 0.01 to 10 weight percent, preferably within the range of 0.1 to 5 weight percent. An excessively low concentration results in an inadequate coverage, and an excessively high concentration does not raise the coverage, conversely tending to decrease it.

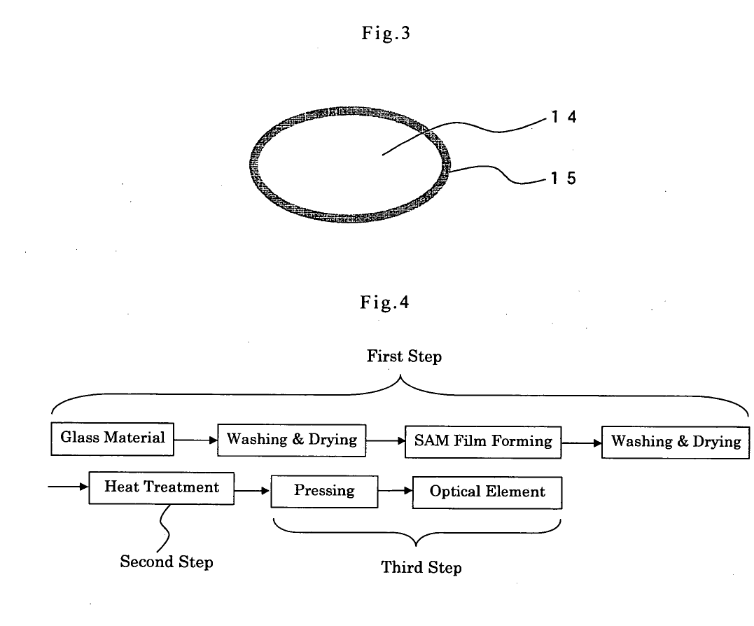

FIG. 3 is a sectional view of a model of the configuration of the glass material of the present invention.

As shown in FIG. 3, the glass material of the present invention comprises self-assembled film 15 formed on the surface of preformed glass 14. Self-assembled film 15 may be obtained, for example, by immersing glass 14 for about one minute in a coating solution prepared by diluting the starting materials of the self-assembled film with an anhydrous organic solvent such as benzene, toluene, xylene, or hexane; removing the glass from the coating solution; washing the glass; and drying the glass for about 30 min at a temperature of about from room temperature to 100° C.

The above immersion method is a convenient treatment method that does not require elaborate equipment, permits uniform and constant control of the state of the surface layer of the glass material, and when employed in press molding, effectively prevents fusion, fogging, clouding, and cracking.

In addition to the immersion method, a self-assembled film can be obtained by exposing the preformed glass to a vapor, mist, or gas containing the starting materials of the self-assembled film.

In the self-assembled film, molecules 2 arrange themselves in orderly fashion on the surface of base material to be coated with film 3 as shown in FIG. 1 as the result of an automatic and spontaneous reaction between the functional groups (O portions) and the surface of base material to be coated with film 3. Accordingly, when forming a self-assembled film, the regular arrangement of atoms can be detected by surface analysis such as IR-RAS showing the peak at which bond IR activity is reflected.

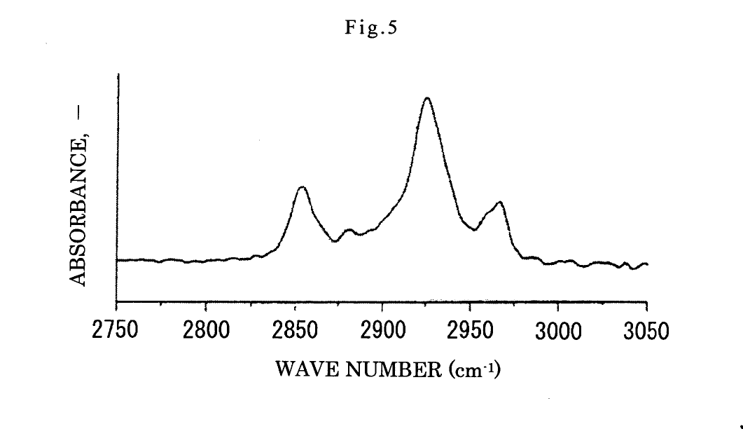

In other words, peaks resulting from the regular arrangement of molecules are observed in IR-RAS analysis as shown in FIG. 5 when a self-assembled film has been formed. However, peaks are not observed in non-selfassembled films in which the molecules are not regularly arranged.

Self-assembled films afford stable thermodynamics, and through the selection of the molecules employed (for example, organic compound molecules), it is readily possible to uniformly control the physical and chemical properties (such as free surface energy) that are dependent on the properties of the functional groups present on the terminals of the molecules. The free surface energy is a yardstick of surface reactivity. A low value indicates poor reactivity and a high value indicates strong reactivity.

The value of free surface energy can normally be quantitatively evaluated by wetting angle measurement using pure water, CH₂I₂, glycerin, isopentane, perfluorohexane, and the like. Evaluation can be conducted with commercial contact angle measurement devices. To obtain the level of free surface energy, two members of the above group of liquids are selected, the wetting angle (contact angle) of the surface being measured is determined, and the value is computed.

In the present application, the free surface energy was calculated by the Owens-Wendt-Kaelble method. For example, the free surface energy can be evaluated in the following manner by the Owens-Wendt-Kaelble method by measurement of the wetting angle using pure water and CH₂I₂.

The free surface energy (γ) is given as the sum of the solid or liquid dispersion force γ^{d} and solid or liquid polar interaction force γ^{p}.

γ=γ^{d}+γ^{p} (1)

Taking equation (1) as the solid free surface energy (γₛ) gives equation (2) below. Here, the subscript s denotes “solid.” Similarly, when considered as a liquid, one obtains equation (3) below, with subscript L denoting “liquid”.

γₛ=γₛ^{d}γₛ^{p} (2)

γ_{L}=γ_{L}^{d}+γ_{L}^{p} (3)

The free surface energy of the film is obtained using two liquids in the form of water and CH₂I₂ (diiodomethane), dripping equal quantities of the two onto a solid, and computing the free surface energy from the contact angles obtained.

The following computation equation was employed with the Owens-Wendt-Kaelble method.

$$\frac{1}{2} \times {γ}_{L} \times ( 1 + cos θ ) = {( {γ}_{s}^{d} \times {γ}_{L}^{d} )}^{\frac{1}{2}} + {( {γ}_{s}^{p} \times {γ}_{L}^{p} )}^{\frac{1}{2}} \qquad ( 4 )$$

Values from the literature, shown in Table 1, were employed for γ_{L}^{d} and γ_{L}^{p} of the two liquids, and the γ_{L} values of the two liquids were obtained from equation (3).

TABLE 1
Energy values of individual liquids (from literature)

| | γ_{L}^{d} | γ_{L}^{p} | γ_{L} |
|---|---|---|---|
| Water | 21.8 | 51 | 72.8 |
| Diiodomethane | 50.8 | 0 | 50.8 |

For example, when the contact angle of water was 104.9° and that of diiodomethane was 72.0°, these were substituted for θ in equations (4) and (5) and the values in Table 1 were employed for the other energy values. The results were as follows:

$$\begin{matrix}\begin{matrix}\frac{1}{2} \times 72.8 \times ( 1 + cos 104.9 ) = {( {γ}_{s}^{d} \times 21.8 )}^{\frac{1}{2}} + {( {γ}_{s}^{p} \times 51.0 )}^{\frac{1}{2}} \\ 27.04 = 4.67 \times {( {γ}_{s}^{d} )}^{\frac{1}{2}} + 7.14 \times {( {γ}_{s}^{p} )}^{\frac{1}{2}}\end{matrix} & ( 5 ) \\ \begin{matrix}\frac{1}{2} \times 50.8 \times ( 1 + cos 72.0 ) = {( {γ}_{s}^{d} \times 50.8 )}^{\frac{1}{2}} + {( {γ}_{s}^{p} \times 0 )}^{\frac{1}{2}} \\ 33.25 = 7.13 \times {( {γ}_{s}^{d} )}^{\frac{1}{2}} + 0 \\ ∴ {γ}_{s}^{d} = 21.76\end{matrix} & ( 6 )\end{matrix}$$

When the γₛ^{d} obtained from equation (6) was substituted into equation (5),

$$\begin{matrix}27.04 = 4.67 \times {( 21.76 )}^{\frac{1}{2}} + 7.14 \times {( {γ}_{s}^{p} )}^{\frac{1}{2}} \\ ∴ {γ}_{s}^{p} = 0.59\end{matrix} \qquad ( 7 )$$

The following results were obtained by substituting the values from (6) and (7) into equation (2).

γₛ=21.76+0.59=22.30

Accordingly, a solid free surface energy γₛ of 22.30 mJ/m² was obtained.

The free surface energy correlates to the magnitude of friction on the surface. The friction can be measured by the lateral force measurement (LFM) method with, for example, a commercial atomic force microscope (AFM) in contact mode.

Table 2 shows an example of free surface energy and thin film surface friction (relative value) measured by the LFM method. Friction was measured by the LFM method using a Si₃N₄ probe with a Nano-Scope III (AFM device) made by Digital Instruments.

A reference sample was employed that consisted of a preformed press glass material for molding on which a carbon film had been formed by vacuum vapor deposition of carbon to an average film thickness of 2.5 nm. A comparative sample was employed that consisted of a film obtained by coating vinyltrichlorosilane (CH₂═CH₂SiCl₃) diluted with ethanol to a thickness of 10 to 50 nm by a spin coater onto an identical preformed glass material. And a sample of the present invention was employed that was obtained by immersing for one minute the same preformed glass material in a solution (2 weight percent concentration) of vinyltrichlorosilane in anhydrous hexane, rinsing the glass material, and drying it at room temperature for 30 min. The film thickness was 0.6 nm.

TABLE 2
The free surface energy and relative friction value
of the film surface as measured by the LFM method

| | Reference | Comparative | Sample of present |
|---|---|---|---|
| | sample | sample | invention |
| Friction (relative | 1.0 | 6.8-9.1 | 0.2 |
| value) | | | |
| Free surface energy | 42 | 64-68 | 25 |
| (mJ/m²) | | | |

The sample of the present invention had lower free surface energy and much lower film surface friction than the comparative sample. This meant that fusion and cracking were prevented and the rate of deformation was high during deformation of the glass during press molding.

The coverage of the film can also be evaluated based on free surface energy. The surface of pure glass is highly reactive, and even once covered with —OH groups, has a high level of free surface energy. Further, bonds (functional groups present at molecular terminals) present on the surface of a self-assembled film have lower reactivity than the glass surface and a lower free surface energy. Accordingly, the free surface energy of the film surface serves as a yardstick of the coverage of a self-assembled film.

For example, denoting the free surface energy of a self-assembled film with a coverage of 100 percent as X mJ/m² and the free surface energy of uncoated glass as Y mJ/m², since there is a linear relation between the coverage and the free surface energy, the coverage of a film with a free surface energy of Z mJ/m² is given by equation (8).

Coverage (%)={1−(Z−X)/(Y−X)}×100 Equ. (8)

When employing the self-assembled film of the present invention, a higher coverage is achieved than when other coating methods are employed. Although it is desirable for the entire film covering the surface of the glass material to be a self-assembled film, the case where some film that is not self-assembled is present is covered by the present invention so long as the scope is such that the effect of the present invention is achieved. The coverage of self-assembled film is desirably greater than or equal to 60 percent, preferably greater than or equal to 80 percent. A coverage of 100 percent means that a clear peak is obtained by IR-RAS when the coating time and temperature are changed, with the height of the peak remaining unchanged (saturation).

As set forth above, the free surface energy is the yardstick of the reactivity and coverage of the surface. The lower the value, the lower the reactivity and the higher the coverage. When the surface energy of the glass material employed in press molding in the present invention is excessively high, reactivity with the pressing mold increases and fogging and clouding are inadequately prevented. Thus, the glass material of the present invention desirably has a free surface energy of less than or equal to 60 mJ/m², preferably less than or equal to 50 mJ/m², and more preferably less than or equal to 40 mJ/m² on its surface.

The thickness of the self-assembled film of the present invention is desirably greater than or equal to 0.1 nm and less than or equal to 30 nm. The self-assembled film formed on the glass material is extended by the molding surface of the mold during press molding. At that time, when the self-assembled film that has been formed on the glass material is excessively thin, extension of the film by press molding produces gaps in the film and the glass and the molding surface come into direct contact, tending to cause fusion. Conversely, when the self-assembled film is excessively thick, the organic compound molecules that have arranged themselves form a structure where they are bonded together, precluding the film from extending during press molding and tending to cause the film to rupture. In that case, the surface of the optical element obtained is rough and clouding and fogging tend to occur. Accordingly, the thickness of the self-assembled film is desirably greater than or equal to 0.5 nm and less than 20 nm, preferably greater than or equal to 0.5 nm and less than 10 nm.

According to the present invention, the thickness of the film can be readily controlled through the selection of the starting materials of the self-assembled film. That is, the thickness of the film can be controlled by means of the length of the organic compound molecules employed as the starting materials. Thus, it is possible to control the film thickness without monitoring the film thickness during film formation. Since a film of identical thickness is always formed when a certain molecule is employed, a good effect is achieved in inhibiting variation in film thickness within lots and between lots. Further, based on the type of glass employed, the film can be readily set thick by selecting organic compound molecules for types of glass tending to crack.

The thickness of a self-assembled film can be measured by ESCA or ellipsometer surface analysis.

Self-assembled films are referred to as self-assembled monolayers (SAMs) in English.

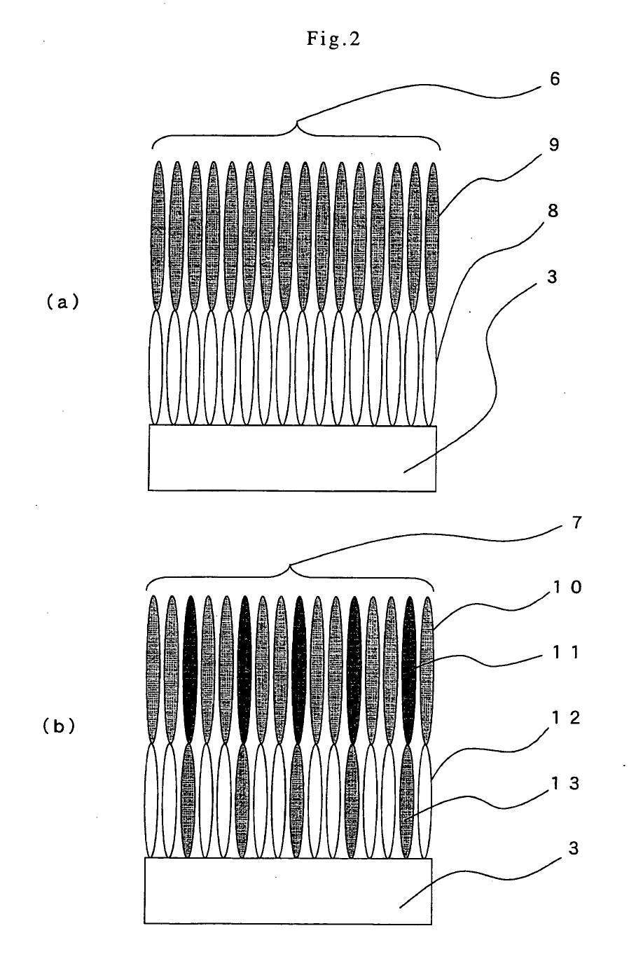

The self-assembled film employed in the present invention can be a single molecular layer formed on the surface by a single film formation process, or can be a multiple molecule layer formed by repeated film formation. That is, the self-assembled film of the present invention need not be a single molecular layer such as is shown in FIG. 1, but may comprise multiple molecular layers 6 and 7 as shown in FIG. 2.

In FIG. 2(a), first layer self-assembled film 8 (the layer on the base material 3 side) and second layer self-assembled film 9 are formed of different compounds. However, each individual layer itself is formed of a single substance. The formation of multiple self-assembled films of different substances in this manner can be anticipated to prevent fusion, clouding, and fogging, and yield an anticracking effect even on optical element shapes that tend to crack and are difficult to mold press.

In FIG. 2(b), first layer self-assembled films 12 and 13 (on the base material 3 side) are formed of difference substances than second layer self-assembled layers 10 and 11. Each of the layers is also formed of multiple substances. The formation of multiple self-assembled films of different substances with each film also being formed of multiple substances can be anticipated to prevent fusion, clouding, and fogging, and yield an anticracking effect even on optical element shapes that tend to crack and are difficult to mold press.

Self-assembled films of the above-described thickness and surface energy, regardless of whether single molecular films or multiple molecular films, are desirable because they effectively inhibit fusion, fogging, clouding, and cracking during press molding of optical elements.

Carbon films obtained by thermal decomposition of self-assembled films will be described next.

The present invention covers a method of manufacturing glass for molding characterized in that the glass material for molding of the present invention having a self-assembled film on its surface is heat treated to thermally decompose at least a portion of the self-assembled film on the glass material.

The self-assembled film is formed of an organic compound incorporating elements such as C, H, F, S, Si, and N. Readily decomposing compounds such as H are reduced by thermal decomposition by heating in a nonoxidizing atmosphere, yielding a carbon thin film comprised chiefly of C. The mold separation property of the mold and the molded product can be reliably maintained by forming a thin carbon film on the surface of the glass material in this manner.

When a self-assembled film is heated in a nonoxidizing atmosphere and thermally decomposed, the chemical bonds in the self-assembled film are severed and a dense, uniform film comprised chiefly of carbon is obtained. Since the carbon in the film has no covalent bondings, sliding is possible within the film in response to elongation of the glass surface due to press molding, yielding a highly flexible film. Accordingly, a particularly marked effect is achieved when employed in readily cracking glass (glass either containing volatile components or having a component for a higher refractive index).

The step of heating a glass material on which has been formed a self-assembled film to thermally decompose the self-assembled film may be conducted either before or after introducing the glass material into the pressing mold for molding. That is, when press molding a glass material, thermal decomposition may be conducted simultaneously with heat softening. When volatile components adhere to the pressing mold due to thermal decomposition, thermal decomposition is desirably conducted outside the mold.

The heat processing temperature for thermal decomposition of the self-assembled film of the glass material of the present invention is desirably greater than or equal to 200° C. and less than or equal to 800° C. When the temperature is excessively low, decomposition of H and the like in the self-assembled film tends to be inadequate, so a heat treatment temperature of greater than or equal to 200° C. is desirable. Further, when the temperature is excessively high, element components such as C, H, F, S, Si, and N in the self-assembled film react with the surface of the glass material, the surface of the glass material is deformed, and defects such as fusion, fogging, clouding, and/or cracking develop. Accordingly, the heat treatment temperature is desirably less than or equal to 800° C. The heat treatment temperature of thermal decomposition of the self-assembled film is preferably greater than or equal to 300° C. and less than or equal to 700° C. The heating time is desirably from 5 to 50 minutes. However, when employing heating by infrared radiation, the desired thermal decomposition is achieved by heating from 5 seconds to 10 minutes.

The film formation coverage and state of the film following heat treatment of the self-assembled film of the present invention can be evaluated in the same manner as the above-described glass material of the present invention having a self-assembled film based on free surface energy analysis by the Owens-Wendt-Kaelble method by wetting angle measurement using pure water, CH₂I₂, glycerin, isopentane, and perfluorohexane. When the surface energy is excessively high, the preventive effect on clouding and fogging tends to be inadequate. Thus, the free surface energy of the glass material following heat treatment is desirably less than or equal to 70 mJ/m², preferably less than or equal to 50 mJ/m².

Following heat treatment, fusion, fogging, clouding, and cracking are efficiently inhibited in the glass material having the above-described surface energy during press molding of optical elements.

The present invention covers methods of manufacturing glass articles comprising the heat softening of the glass material of the present invention having the above-described self-assembled film or a glass material obtained by the method of heat treating the glass material of the present invention having the above-described self-assembled film, followed by press molding in a pressing mold.

FIG. 4 is a process drawing showing a model of the method of manufacturing glass articles of the present invention.

In the first step, a self-assembled film is formed on the surface of a glass material used in the molding of an optical element. The self-assembled film is obtained by diluting the starting materials of the self-assembled film with an anhydrous organic solvent to prepare a coating solution, washing and drying the glass material, immersing the glass material for about one minute in the coating solution, removing the glass material from the coating solution, and washing and drying the glass material.

In the second step, a glass material on the surface of which has been formed a self-assembled film is heat treated for from several seconds to several tens of minutes in an inert gas atmosphere such as N₂, He, and Ar to thermally decompose the self-assembled film and synthesize a thin carbon containing film. The heat treatment temperature is desirably greater than or equal to 200° C. and less than or equal to 800° C. Reduced pressure may be employed so long as the pressure of the inert gas atmosphere is greater than or equal to 10⁻⁵ Torr.

In the third step, the glass material is press molded by a known means to obtain an optical glass element. The glass material on which has been formed a self-assembled film and which has been heat treated can be press molded by a known means to obtain an optical glass element. For example, the glass material is introduced into a pressing mold of precise shape, heated to a temperature corresponding to the temperature at which the glass material exhibits a viscosity of from 10⁸ to 10¹² poises, softened, and pressed to transfer the molding surface of the mold to the glass material. Alternatively, a glass material that has been heated in advance to a temperature corresponding to a viscosity of from 10⁸ to 10¹² poises can be introduced to a precisely shaped pressing mold and pressed to transfer the molding surface of the mold to the glass material. The atmosphere during molding is desirably a nonoxidizing atmosphere. Subsequently, the mold and the glass material are cooled, and preferably at a temperature of at or below the Tg, the mold is separated and the molded optical element is extracted.

A material selected from among SiC, WC, TiC, TaC, BN, TiN, AlN, Si₃N₄, SiO₂, Al₂O₃, ZrO₂, W, Ta, Mo, cermet, cyalon, mullite, carbon composite (C/C), carbon fiber (CF), WC-Co alloy, glass materials comprising crystallized glass, and stainless steel-based highly heat resistant metals can be employed as the base of the mold.

A mold separation film is desirably provided on the molding surface of the base. Diamond-like carbon film (DLC hereinafter), hydrogenated diamond-like carbon film (DLC:H hereinafter), tetrahedral amorphous carbon film (ta-C hereinafter), hydrogenated tetrahedral amorphous carbon film (ta-C:H hereinafter), amorphous carbon film (a-C hereinafter), hydrogenated amorphous carbon film (a-C:H hereinafter), carbon-based films such as nitrogen-comprising carbon films, and alloy films comprising at least one metal selected from among the group consisting of platinum (Pt), palladium (Pd), iridium (Ir), rhodium (Rh), osmium (Os), ruthenium (Ru), rhenium (Re), tungsten (W), and tantalum (ta) may be employed as the mold separating film.

Further, the mold separating film may be formed by a method such as the DC-plasma CVD method, RF-plasma CVD method, microwave plasma CVD method, ECR-plasma CVD method, optical CVD method, laser CVD method, or some other plasma CVD method; the ion plating method or some other ionization vapor deposition method; sputtering; vapor deposition; FCA; or the like.

The present invention is particularly suited to molding glass materials comprised of optical glass containing volatile components (alkali metals or fluorine). That is because fusion and the like induced by volatile components deposited in the mold separating film is effectively inhibited.

Further, the present invention is effective when components for higher refractive index such as reductive Ti, Nb, or W are contained. The film of the present invention prevents reaction even by glass with high reactivity to the mold surface, thereby preventing fusion and clouding. The present invention is even effective on phosphate glass particularly prone to fusion.

In addition to being effective in optical elements such as lenses, mirrors, gratings, prisms, microlenses, stacked diffraction optical elements, and the like, the present invention is suited to molded glass articles other than optical elements.

### EXAMPLES

The present invention is described in greater detail below through embodiments.

### Example 1

A glass material obtained by forming a self-assembled film on the surface of a core of preformed glass was prepared. That is, a glass material was immersed for 60 seconds at 20° C. in a coating solution prepared by diluting n-octadecyltrichlorosilane (CH₃(CH₂)₁₇SiCl₃) to 1 weight percent with anhydrous hexane, and the glass material was removed from the coating solution, washed, and dried for about 30 min at room temperature. The optical glass employed as the core glass (glass material) was borate glass containing volatile components in the form of alkali metal oxides and had a glass transition temperature of 520° C., a refractive index of 1.69350, and a linear expansion coefficient of 69×10⁻⁷/° C.

Since only local analysis is possible by IR-RAS, an FT/IR620 unit made by Nippon Bunko was employed to analyze 10 random points on the surface of the glass material. In the results shown in FIG. 5, peaks derived from self-assembled film were observed at all 10 measurement points, confirming that the film formed on the surface of the glass material was self-assembled. In ESCA evaluation results, the average thickness of the self-assembled film was 4.0 nm, the film thickness at the center portion of the glass material was 4.0 nm, and the film thickness at the peripheral portion of the glass material was 4.0 nm, indicating uniform film thickness.

The surface energy analyzed by the Owens-Wendt-Kaelble method of wetting angle measurement with pure water and CH₂I₂ was 25 to 28 mJ/m².

Since the peak height was saturated when IR-RAS evaluation was conducted by changing the film forming time, the coating rate calculated from this free surface energy was set to be 100 percent.

Further, the surface friction (a relative value of the net friction relative to a vapor deposited carbon film sample) measured by the LFM method using a Nano-Scope HI unit made by Digital Instruments was 0.2, an extremely low value.

The structural molecule of the self-assembled film was a C₁₈H₃₇Si— glass material. ESCA analysis results indicated that the self-assembled film contained the three elements of C, H, and Si.

The glass material coated with a self-assembled film surface layer was placed in a molding device. In a nitrogen environment, heat was applied for 15 min to 610° C. and pressing was conducted for one minute at a pressure of 150 kg/cm². After releasing the pressure, cooling was conducted to 480° C. at a rate of −50° C./min, after which cooling was conducted at a rate of −100° C./min or more. Once the temperature of the press molded product had dropped to 200° C. or less, the molded product was removed. The pressing mold employed had molding surfaces of polycrystalline SiC formed by CVD that were polished to Rmax=18 nm and then the molding surface was coated with a DLC:H film (hydrogenated diamond-like carbon film) by using an ion plating film forming device.

Continuous press molding was conducted with a single mold. Observation revealed the external appearance of all optical elements to be good through 500 pressings.

### Comparative Example 1

A coating solution prepared by diluting n-octadecyltrichlorosilane (CH₃(CH₂)₁₇SiCl₃) to 2 weight percent with ethanol was coated on a preformed glass material with a spin coater. Ten random points on the surface of the glass material were analyzed by IR-RAS, revealing no peaks at any of the ten points and revealing no assembled structure in the film formed on the surface of the glass material. That is, the film formed on the surface of the glass material was confirmed not to be the self-assembled film of the present invention.

The film thickness as measured by ESCA was 200 to 450 nm, the film thickness at the center portion of the glass material was 300 to 450 nm, and the film thickness at the peripheral portion of the glass material was 200 to 350 nm, indicating that the film thickness was nonuniform. The surface energy as analyzed by the Owens-Wendt-Kaelble method by measurement of the wetting angle with pure water and CH₂I₂ was 50 to 72 mJ/m².

Further, the surface friction as measured by the LFM method in the same manner as in Example 1 was 3.1 to 5.9. These numbers are larger than in Example 1 and nonuniform. The results revealed that the reactivity of the film was high and the coverage was lower than that in Example 1.

ESCA analysis revealed that in addition to C, H, and Si, the film contained the element O (oxygen). This was thought to have been the result of the hydrolysis reaction of reaction (4) occurring at the stage of dilution of the solution with ethanol, producing C₁₈H₃₇Si—O—C₂H₅ molecules or aggregates thereof (a sol, gel, or the like) that adhered to the glass material.

In the same manner as in Example 1, continuous pressing was conducted with a single mold. Cracking appeared in the optical elements at the 80^{th} pressing and fused matter thought to be glass was observed on the pressing mold. No further pressing was possible with the pressing mold and regeneration of the separating film on the surface of the pressing mold was necessary.

### Examples 2 to 9

With the exception that the glass, coating solution, and film forming conditions were varied as indicated in Tables 3 to 5, glass materials coated with self-assembled films were prepared in the same manner as in Example 1 and continuous pressing was conducted in a single mold. Observation of the external appearance of the optical elements at the 500^{th} pressing revealed almost no clouding, fogging, or cracking, as indicated in Tables 3-5, and the quality of the external appearance was either good or extremely good.

### Example 10

The glass of Table 5 was employed. A preformed glass material was immersed for 30 seconds to form a film in a coating solution prepared by diluting trichlorovinylsilane, the starting material of a self-assembled film, to 20 weight percent with anhydrous benzene. Ten points on the surface of the glass material were analyzed by IR-RAS; peaks were observed at 8 points.

The average film thickness as evaluated by ESCA was 0.3 nm, the film thickness at the center portion of the glass material was 0.2 nm, and the film thickness at the peripheral portion was 0.3 to 0.4 nm. The surface energy as analyzed by wetting angle measurement with pure water and CH₂I₂ was 38 to 52 mJ/m².

Continuous pressing was conducted with a single mold as in Example 1. Observation of the external appearance of the optical elements through the 500^{th} pressing, as shown in FIG. 5, revealed almost no fogging, clouding, or cracking and good external appearance.

### Comparative Example 2

A preformed glass material was immersed for 30 seconds to form a film in a coating solution prepared by diluting trichlorovinylsilane, the starting material of a self-assembled film, to 20 weight percent with benzene containing about 0.1 percent H₂O. Ten points on the surface of the glass material were analyzed by IR-RAS, revealing a peak at only one point and no self-assembly in most parts of the film formed on the surface of the glass material. The average thickness as evaluated by ESCA was 1.1 nm, the thickness at the center portion of the glass material was 0.2 nm, and the thickness at the peripheral portion was 0 to 2.1 nm. The surface energy as analyzed by wetting angle measurement with pure water and CH₂I₂ was 51 to 68 mJ/m².

When continuous pressing was conducted with a single mold in the same manner as in Example 1, cracking appeared in the optical elements at the 25^{th} pressing. Further, fused matter thought to be glass was observed on the pressing mold. No further pressing with the pressing mold was possible and regeneration of the mold separating film on the surface of the pressing mold was necessary.

TABLE 3
Table of Examples and Comparative Examples

| Item | Example 1 | Comp. Example 1 | Example 2 | Example 3 |
|---|---|---|---|---|
| Glass (Tg/Ts) | Borate-based glass | Borate-based | Phosphate-based | Phosphate-based |
| | containing alkali | glass containing | glass containing | glass containing F |
| | metal oxide | alkali metal oxide | alkali metal oxide | (420° C./480° C.) |
| | (520° C./560° C.) | (520° C./560° C.) | (480° C./530° C.) | |
| Coating | Anhydrous hexane | Ethanol solution | Anhydrous hexane | Anhydrous hexane |
| solution | solution of 1 wt % | of 2 wt % | solution of 0.01 | solution of 1 wt % |
| | n-octadecyl | n-octadecyl | wt % octyl | octyl |
| | trichlorosilane | trichlorosilane(CH₃(CH₂)₁₇SiCl₃) | trichlorosilane | trichlorosilane |
| | (CH₃(CH₂)₁₇SiCl₃) | | (CH₃(CH₂)₇SiCl₃) | CH₃(CH₂)₇SiCl₃) |
| Film forming | Immersion | Spin coater film | Immersion | Immersion |
| conditions | (20° C./60 sec) | formation | (0° C./1 sec) | repeated 10 times |
| (Conditions) | | | | (20° C./60 sec) |
| Self-assembly* | Good (10/10) | Poor (0/10) | Good (9/10) | Good (10/10) |
| Average film | 4.0 nm | 200-450 nm | <0.1 nm | 46 nm |
| thickness | | | | |
| Film thickness | 4.0 nm | 300-450 nm | 1.2 nm | 44 nm |
| at center | | | | |
| Film thickness | 4.0 nm | 200-350 nm | 1.8 nm | 47 nm |
| at periphery | | | | |
| Free surface | 25-28 mJ/m² | 50-72 mJ/m² | 25-52 mJ/m² | 34-65 mJ/m² |
| energy | | | | |
| Coverage** | 100% | — | 60% | 85% |
| Friction*** | 0.2 | 3.1-5.9 | 0.8 | 0.5 |
| Film | C, H, Si | C, H, Si, O | C, H, Si | C, H, Si |
| components | | | | |
| Film structure | C₁₈H₃₇Si— glass | Adhesion of | C₈H₁₇Si— glass | (C₈H₁₇Si)₁₀— glass |
| | material | C₁₈H₃₇Si—O—C₂H₅ | material | material |
| | | molecules or their | | |
| | | aggregates | | |
| | | (sol, gel, etc.) | | |
| External | B | C | B | B |
| appearance of | | | | |
| optical | | | | |
| element**** | | | | |

*Determination of self-assembly: Determination of the presence or absence of peaks by IR-RAS measurement (using FT/IR620 made by Nippon Bunko) Numbers in parentheses are number of times peaks were observed in IR-RAS measurement of 10 points.
**Coverage: Value computed using equation (8)
***Friction: Value of friction measured by LFM method using Nano-Scope III unit made by Digital Instruments relative to vapor deposited carbon film sample
****External appearance of optical element: External appearance of optical element through 500^{th} pressing in continuous pressing with the same mold.
A: No cracking, clouding, or fogging up to 500^{th} pressing.
B: Fewer than 10 optical elements exhibiting cracking, clouding, or fogging up to 500^{th} pressing
C: Cracking appearing during pressing

TABLE 4
Table of Examples and Comparative Examples

| Item | Example 4 | Example 5 | Example 6 | Example 7 |
|---|---|---|---|---|
| Glass (Tg/Ts) | Phosphate-based | Borosilicate- | Phosphate-based | Phosphate-based glass |
| | glass containing | based glass | glass containing | containing F |
| | alkali metal oxide | containing | alkali metal oxide | (420° C./480° C.) |
| | (480° C./530° C.) | alkali metal | (480° C./530° C.) | |
| | | oxide | | |
| | | (515° C./545° C.) | | |
| Coating | Anhydrous | Anhydrous | Anhydrous hexane | Anhydrous hexane |
| solution | benzene solution | toluene solution | solution of 1 wt % | solution of 0.5 wt % |
| | of 3 wt % | of 0.5 wt % 1- | octatrichlorosilane | dieicosyldimethyl |
| | trichiorovinyl- | decanethiol | (CH₃(CH₂)₁₁SiCl₃) | ammonium bromide |
| | silane | (CH₃(CH₂)₉SH) | | (CH₂(CH₂)₁₉)₂(CH₃)₂NBr) |
| | (CH₂═CH₂SiCl₃) | | | |
| Film forming | Immersion | Immersion | Immersion | Immersion |
| conditions | (20° C./40 sec) | (20° C./120 sec) | (20° C./60 sec) | (20° C./180 sec) |
| (Conditions) | | | | |
| Self- | Good (10/10) | Good (10/10) | Good (10/10) | Good (10/10) |
| assembly* | | | | |
| Average film | 0.5 nm | 2.6 nm | 1.1 nm | 3.8 nm |
| thickness | | | | |
| Film | 0.5 nm | 2.6 nm | 1.1 nm | 4.4 nm |
| thickness at | | | | |
| center | | | | |
| Film | 0.0 nm | 2.6 nm | 1.1 nm | 3.4 nm |
| thickness at | | | | |
| periphery | | | | |
| Free surface | 36 mJ/m² | 28 mJ/m² | 28 mJ/m² | 26 mJ/m² |
| energy | | | | |
| Coverage** | 95% | 100% | 100% | 100% |
| Friction*** | 0.2 | 0.7 | 0.8 | 0.5 |
| Film | C, H, Si | C, H, S | C, H, S | C, H, N |
| components | | | | |
| Film | C₂H₄Si— glass | C₁₀H₂₁S— glass | C₁₂H₂₅Si— glass | (CH₂(CH₂)₁₉)₂(CH₃)₂N |
| structure | material | material | material | glass material |
| External | A | A | A | A |
| appearance | | | | |
| of optical | | | | |
| element**** | | | | |

*Determination of self-assembly: Determination of the presence or absence of peaks by IR-RAS measurement (using FT/IR620 made by Nippon Bunko) Numbers in parentheses are number of times peaks were observed in IR-RAS measurement of 10 points).
**Coverage: Value computed using equation (8)
***Friction: Value of friction measured by LFM method using Nano-Scope III unit made by Digital Instruments relative to vapor deposited carbon film sample
****External appearance of optical element: External appearance of optical element through 500^{th} pressing in continuous pressing with the same mold.
A: No cracking, clouding, or fogging up to 500^{th} pressing.
B: Fewer than 10 optical elements exhibiting cracking, clouding, or fogging up to 500^{th} pressing
C: Cracking appearing during pressing

TABLE 5
Table of Examples and Comparative Examples

| Item | Example 8 | Example 9 | Example 10 | Comp. Example 2 |
|---|---|---|---|---|
| Glass (Tg/Ts) | Borate-based glass | Borate-based | Phosphate-based | Phosphate-based |
| | containing alkali | glass containing | glass containing F | glass containing F |
| | metal oxide | alkali metal oxide | (420° C./480° C.) | (420° C./480° C.) |
| | (520° C./560° C.) | (520° C./560° C.) | | |
| Coating | Anhydrous xylene | Anhydrous | Anhydrous benzene | Benzene solution of |
| solution | solution of 0.5 | hexane solution | solution of 20 wt % | 0.5 wt % |
| | wt % diallyl | of 1 wt % | trichlorovinylsilane | trichlorovinylsilane |
| | disufide | dipropyl disulfide((C₂H₇)₂S)₂) | (CH₂═CH₂SiCl₃) | (CH₂═CH₂SiCl₃) |
| | ((CH₂═CHCH₂S)₂) | | | |
| Film forming | 20° C./150 sec | 20° C./40 sec | Immersion | Immersion |
| conditions | immersion | immersion | (20° C./30 sec) | (20° C./30 sec) |
| (Conditions) | | | | |
| Self- | Good (10/10) | Good (10/10) | Good (8/10) | Poor (1/10) |
| assembled* | | | | |
| Average film | 1.1 nm | 1.2 nm | 0.3 nm | 1.1 nm |
| thickness | | | | |
| Film thickness | 1.2 nm | 1.3 nm | 0.2 nm | 0.2 nm |
| at center | | | | |
| Film thickness | 1.0 nm | 1.2 nm | 0.3-0.4 nm | 0-2.1 nm |
| at periphery | | | | |
| Free surface | 28 mJ/m² | 23 mJ/m² | 38-52 mJ/m² | 51-68 mJ/m² |
| energy | | | | |
| Coverage** | 100% | 0% | 60% | 85% |
| Friction*** | 0.2 | 0.4 | 0.7-0.9 | 1.5-4.2 |
| Film | C, H, S | C, H, S | C, H, Si | C, H, Si, O |
| components | | | | |
| Film structure | C₃H₅S— glass | C₄H₁₄S— glass | C₂H₄Si— glass | C₂H₄SiO gel, one |
| | material | material | material | small portion of |
| | | | | which was C₂H₄Si |
| | | | | glass material |
| External | A | A | B | C |
| appearance of | | | | |
| optical | | | | |
| element**** | | | | |

*Determination of self-assembly: Determination of the presence or absence of peaks by IR-RAS measurement (using FT/IR620 made by Nippon Bunko) Numbers in parentheses are number of times peaks were observed in IR-RAS measurement of 10 points).
**Coverage: Value computed using equation (8)
***Friction: Value of friction measured by LFM method using Nano-Scope III unit made by Digital Instruments relative to vapor deposited carbon film sample
****External appearance of optical element: External appearance of optical element through 500^{th} pressing in continuous pressing with the same mold.
A: No cracking, clouding, or fogging up to 500^{th} pressing.
B: Fewer than 10 optical elements exhibiting cracking, clouding, or fogging up to 500^{th} pressing
C: Cracking appearing during pressing

### Example 11

In the first step, a glass material (composition: borate-based glass) was immersed for 60 sec at 20° C. in a coating solution prepared by diluting n-octadecyl trichlorosilane (CH₃(CH₂)₁₇SiCl₃) to 1 weight percent with anhydrous hexane. The glass material was then removed from the coating solution, washed, and dried for about 30 min at room temperature.

The glass material was comprised of borate-based glass containing volatile components in the form of alkali metal oxides. The glass had a transition temperature of 520° C., a refractive index of 1.69350, and a linear expansion coefficient of 69×10⁻⁷/° C. Ten points on the surface of the glass material were analyzed by IR-RAS using an FT/IR620 unit made by Nippon Bunko. As a result, peaks derived from self-assembled films were observed in measurement at all 10 points, and nearly the entire surface of the film formed on the surface of the glass material was found to have been self-assembled.

Further, ESCA evaluation revealed that the average film thickness of the self-assembled film was 4.0 nm, the film thickness in the center portion of the glass material was 4.0 nm, and the film thickness at the peripheral portion of the glass material was 4.0 mm, indicating uniform film thickness. The surface energy as analyzed by the Owens-Wendt-Kaelble method based on measurement of pure water and CH₂I₂ wetting angles was 25 to 28 mJ/m².

In the second step, the glass material was heated to 400° C. for 30 sec with an infrared heater in a N₂ gas atmosphere at atmospheric pressure in a heat treatment. Following heating, the surface energy of the surface of the glass material as analyzed by the Owens-Wendt-Kaelble method based on measurement of pure water and CH₂I₂ wetting angles was 48-51 mJ/m². The change in free surface energy from 25 to 28 mJ/m² to 48 to 51 mJ/m² by heating was attributed to conversion of the CH₃ group on the film surface to C.

The coverage calculated from the free surface energy was 90 percent or more. Further, ESCA evaluation of the film thickness revealed the average film thickness to be 2.2 nm, the film thickness in the center of the glass material to be 2.1 nm, and the film thickness in the peripheral portion of the glass material to be 2.3 nm, indicating a substantially uniform film thickness. The decrease in film thickness due to heating (from 4.0 nm to 2.2 nm) was attributed to elimination of some of the carbon atoms during thermal decomposition. The ESCA analysis results revealed that the structural molecules of the film were C, Si, and a small amount of H, with H having decreased.

Further, the surface friction (a value relative to a vapor deposed carbon film) measured by the LFM method with a Nano-Scope III unit made by Digital Instruments was 0.9, indicating low friction.

In the third step, the glass material coated with a self-assembled film surface layer was placed in a molding device, heated to 610° C. in a nitrogen gas atmosphere, and pressed for 1 minute at 150 kg/cm². After releasing the pressure, the glass material was cooled at a rate of 50° C./min to 480° C., and then cooled at a rate of −100° C./min or more. Once the temperature of the press molded product had reached 200° C. or below, the molded product was removed. The pressing mold employed had molding surfaces of polycrystalline SiC formed by CVD that were polished to Rmax=18 nm and then the molding surface was coated with a DLC:H film using an ion plating film forming device.

Continuous pressing was conducted with a single mold. Observation revealed the external appearance of all optical elements to be extremely good through 500 pressings.

### Comparative Example 3

A film of coating solution prepared by diluting n-octadecyltrichlorosilane (CH₃(CH₂)₁₇SiCl₃) to 2 weight percent with ethanol was formed by spin coater on a preformed glass material.

Analysis of ten points on the glass material surface by IR-RAS (an FT/IR620 device made by Nippon Bunko) revealed peaks at none of the ten points and no assembled structure was found in the film formed on the glass material surface. That is, the film formed on the surface of the glass material was confirmed not to be the self-assembled film of the present invention.

The film thickness as measured by ESCA was 200 to 450 nm, with a film thickness of 300 to 450 nm in the center of the glass material and 200 to 350 nm in peripheral portions of the glass material. The film thickness was thus nonuniform. Analysis by ESCA revealed that in addition to C, H, and Si, the film also contained O (oxygen) atoms. This was thought to be C₁₈H₃₇Si—O—C₂H₅ molecules, or their aggregates (sols, gels, or the like), produced in the hydrolysis reaction of reaction equation (4) during the step of dilution with ethanol solution, that had adhered to the glass material.

Analysis by the Owens-Wendt-Kaelble method by measuring the pure water and CH₂₁₂ wetting angles revealed the surface energy to be 50 to 72 mJ/m².

In step 2, in the same manner as in Example 11, the glass material was heated to 400° C. for 30 sec with an infrared heater in an N₂ gas atmosphere at atmospheric pressure as a heat treatment. Analysis by the Owens-Wendt-Kaelble method by measuring the pure water and CH₂I₂ wetting angles revealed the surface energy of the glass material to be 61 to 72 mJ/m² following heating.

The film thickness as measured by ESCA was 100 to 310 nm, the film thickness at the center of the glass material was 100 to 280 nm, and the film thickness at the periphery of the glass material was 130 to 310 nm, which was extremely nonuniform. ESCA analysis revealed the constituent elements of the film to be C, Si, O, and a small amount of H.

Further, the frictional force (a value relative to a vapor deposited carbon film) as measured by the LFM method using a Nano-Scope III unit made by Digital Instruments was 2.8 to 5.6. The friction was thus extremely high.

In the third step, the glass material that had been coated with a self-assembled film surface layer was placed in a molding device, heated to 610° C. in a nitrogen gas atmosphere, and pressed for 1 min at 150 kg/cm². After releasing the pressure, the glass material was cooled to 480° C. at the rate of −50° C./min, and then cooled at a rate of greater than or equal to 100° C./min. When the temperature of the press molded product had dropped to 200° C. or below, the molded product was removed. The pressing mold employed had molding surfaces of polycrystalline SiC formed by CVD that were polished to Rmax=18 nm and then the molding surface was coated with a DLC:H film using an ion plating film forming device.

In the same manner as in Example 11, continuous pressing was conducted with a single mold. At the 60^{th} pressing, cracking occurred in the optical element and fused matter thought to be glass was observed on the pressing mold. No further pressing was possible with the pressing mold, and regeneration of the mold separation film on the surface of the pressing mold was necessary.

### Example 12

In the first step, in the same manner as in Example 11, a glass material (composition: borate-based glass) was immersed for 60 sec at 20° C. in a coating solution prepared by diluting n-octadecyl trichlorosilane (CH₃(CH₂)₁₇SiCl₃) to 1 weight percent with anhydrous hexane. The glass material was then removed from the coating solution, washed, and dried for about 30 min at room temperature. The glass material was comprised of borate-based glass containing volatile components in the form of alkali metal oxides. The glass had a transition temperature of 520° C., a refractive index of 1.69350, and a linear expansion coefficient of 69×10⁻⁷/° C.

Ten points on the surface of the glass material were analyzed by IR-RAS using an FT/IR620 unit made by Nippon Bunko. As a result, peaks derived from self-assembled films were observed in measurement at all 10 points, and nearly the entire surface of the film formed on the surface of the glass material was found to have been self-assembled.

Further, ESCA evaluation revealed that the average film thickness of the self-assembled film was 4.0 nm, the film thickness in the center portion of the glass material was 4.0 nm, and the film thickness at the peripheral portion of the glass material was 4.0 mm, indicating uniform film thickness.

The surface energy as analyzed by the Owens-Wendt-Kaelble method based on measurement of pure water and CH₂I₂ wetting angles was 25 to 28 mJ/m².

The second and third steps were continuously conducted in the pressing step. The glass material was placed on the mold of a pressing device, and in the course of being heated to a pressing temperature of 610° C. in an N₂ gas atmosphere at atmospheric pressure, was subjected to a heating step in which it was maintained for 15 min at 400° C. as a heat treatment. The glass material was then positioned within the molding device.

The glass material was heated to 610° C. and pressed for 1 minute at a pressure of 150 kg/cm² in a nitrogen gas atmosphere. Following release of the pressure, cooling was conducted to 480° C. at a rate of −50° C./min, followed by cooling at a rate of −100° C./min. When the temperature of the press molded product had dropped to 200° C. or below, the molded product was removed. The pressing mold employed had molding surfaces of polycrystalline SiC formed by CVD that were polished to Rmax=15 nm and then the molding surface was coated with a DLC:H film using an ion plating film forming device. Observation of optical elements obtained in 500 continuous pressings in a single mold revealed the external appearance of all the optical elements to be quite good.

Evaluation of the glass material when removed after heating but before pressing yielded the following results. The surface energy of the glass material as analyzed by the Owens-Wendt-Kaelble method based on measurement of pure water and CH₂I₂ wetting angles was 42 to 48 mJ/m². The coverage calculated from the free surface energy was 90 percent or more. Further, ESCA evaluation of the film thickness revealed the average film thickness to be 2.3 nm, the film thickness in the center of the glass material to be 2.5 nm, and the film thickness in the peripheral portion of the glass material to be 2.1 nm, indicating a substantially uniform film thickness.

The decrease in film thickness due to heating (from 4.0 nm to 2.3 nm) was attributed to elimination of some of the carbon atoms during thermal decomposition. The ESCA analysis results revealed that the structural molecules of the film were C, Si, and a small amount of H, with H having decreased. Further, the frictional force (a value relative to a vapor deposed carbon film) measured by the LFM method with a Nano-Scope III unit made by Digital Instruments was 0.8, indicating low friction.

### Examples 13 to 21

With the exceptions that the glass, coating solution, film forming conditions, and heat treatment conditions were varied as indicated in Tables 6 to 8, optical element molding materials on which self-assembled films had been formed were heat treated and continuously pressed with a single mold and the external appearance of the optical elements was observed through 500 pressings in the same manner as in Example 11. The results, given in Tables 6 to 8, indicated that there was almost no clouding, fogging, or cracking, and the quality of the external appearance was extremely good.

### Comparative Example 4

In the same manner as in Example 11, a glass material (composition: borate-based glass) was immersed for 60 sec at 20° C. in a coating solution prepared by diluting n-octadecyl trichlorosilane (CH₃(CH₂)₁₇SiCl₃) to 1 weight percent with anhydrous hexane. The glass material was then removed from the coating solution, washed, and dried for about 30 min at room temperature. The glass material was comprised of borate-based glass containing volatile components in the form of alkali metal oxides. The glass had a transition temperature of 520° C., a refractive index of 1.69350, and a linear expansion coefficient of 69×10⁻⁷/° C.

Ten points on the surface of the glass material were analyzed by IR-RAS using an FT/IR620 unit made by Nippon Bunko. As a result, peaks derived from self-assembled films were observed in the measurements at all 10 points, and nearly the entire surface of the film formed on the surface of the glass material was found to have been self-assembled. Further, ESCA evaluation revealed that the average film thickness of the self-assembled film was 4.0 nm, the film thickness in the center portion of the glass material was 4.0 nm, and the film thickness at the peripheral portion of the glass material was 4.0 mm, indicating uniform film thickness.

The surface energy as analyzed by the Owens-Wendt-Kaelble method based on measurement of pure water and CH₂I₂ wetting angles was 25 to 28 mJ/m².

In the second step, the glass material was heated to 850° C. for 30 sec with an infrared heater in a N₂ gas atmosphere at atmospheric pressure in a heat treatment. Following heating, the surface energy of the surface of the glass material as analyzed by the Owens-Wendt-Kaelble method based on measurement of pure water and CH₂I₂ wetting angles was 67 to 72 mJ/m². The film thickness was evaluated by ESCA, but no film was detected on the glass material surface.

The change in free surface energy from 25 to 28 mJ/m² to 67 to 72 mJ/m² due to heating was seen as the result of the elimination of the film. The heat treatment at the elevated temperature of 850° C. was thought to have decomposed the film, thus eliminating the film. Further, the surface friction (a value relative to a vapor deposed carbon film) measured by the LFM method with a Nano-Scope III unit made by Digital Instruments was 3.2, indicating high friction.

When continuous pressing was conducted with a single mold in the same manner as in Example 11, the glass material cracked at the 30^{th} pressing and fused material thought to be glass was observed on the pressing mold. No further pressing was possible with the pressing mold, and regeneration of the mold separating film on the surface of the pressing mold was necessary.

TABLE 6
Table of Examples and Comparative Examples

| Item | Example 11 | Comp. Example 3 | Example 12 | Example 13 |
|---|---|---|---|---|
| Glass (Tg/Ts) | Borate-based glass | Borate-based glass | Borate-based glass | Phosphate-based |
| | containing alkali | containing alkali | containing alkali | glass containing F |
| | metal oxide | metal oxide | metal oxide | (420° C./480° C.) |
| | (520° C./560° C.) | (520° C./560° C.) | (520° C./560° C.) | |
| Coating | Anhydrous hexane | Ethanol solution of | Anhydrous hexane | Anhydrous hexane |
| solution | solution of 1 wt % | 2 wt % n- | solution of 1 wt % n- | solution of 1 wt % |
| | n-octadecyl | octadecyltrichloro- | octadecyltrichloro- | octyltrichloro- |
| | trichlorosilane | silane | silane | silane |
| | (CH₃(CH₂)₁₇SiCl₃) | (CH₃(CH₂)₁₇SiCl₃) | (CH₃(CH₂)₁₇SiCl₃) | (CH₃(CH₂)₇SiCl₃ |
| Film forming | Immersion | Spin coater film | Immersion (20° C./60 | Ten repeated |
| conditions | (20° C./60 sec) | formation | sec) | immersions |
| (Conditions) | | | | (20° C./60 sec) |
| Self- | Good (10/10) | Poor (0/10) | Good (10/10) | Good (10/10) |
| assembly* | | | | |
| Average film | 4.0 nm | 200-450 nm | 4.0 nm | 46 nm |
| thickness | | | | |
| Film thickness | 4.0 nm | 300-450 nm | 4.0 nm | 44 nm |
| at center | | | | |
| Film thickness | 4.0 nm | 200-350 nm | 4.0 nm | 47 nm |
| at periphery | | | | |
| Free surface | 25-28 mJ/m² | 50-72 mJ/m² | 42-48 mJ/m² | 34-65 mJ/m² |
| energy | | | | |
| Coverage** | 100% | — | 60% | 85% |
| Composition | C₁₈H₃₇Si— glass | Adhesion of | C₈H₁₇Si— glass | (C₈H₁₇Si)₁₀— glass |
| of film prior to | material | C₁₈H₃₇Si—O—C₂H₅ | material | material |
| heat treatment | | molecules or their | | |
| | | aggregates (sols, | | |
| | | gels, etc) | | |
| Heat treatment | 400° C./30 sec | 400° C./30 sec | heating in pressing | 400° C./30 sec |
| | | | step (heating over 15 | |
| | | | min to 650° C.) | |
| Average film | 2.2 nm | 100-310 nm | 2.3 | 38 nm |
| thickness after | | | | |
| heat treatment | | | | |
| Film thickness | 2.1 nm | 100-280 nm | 2.5 | 31 nm |
| in center | | | | |
| portion after | | | | |
| heat treatment | | | | |
| Film thickness | 2.3 nm | 130-310 nm | 2.1 | 40 nm |
| at periphery | | | | |
| after heat | | | | |
| treatment | | | | |
| Free surface | 48-51 mJ/m² | 61-72 mJ/m² | 42-48 mJ/m² | 44-52 mJ/m² |
| energy after | | | | |
| heat treatment | | | | |
| Coating rate | ≧90% | 90% | ≧90% | ≧90% |
| after heat | | | | |
| treatment** | | | | |
| Friction after | 0.9 | 2.8-5.6 | 0.8 | 0.9 |
| heat | | | | |
| treatment*** | | | | |
| Film | C, Si, small | C, Si, O, small | C, Si, small amount | C, Si, small |
| components | amount of H | amount of H | of H | amount of H |
| External | A | C | A | B |
| appearance of | | | | |
| optical | | | | |
| element**** | | | | |

*Determination of self-assembly: Determination of the presence or absence of peaks by IR-RAS measurement (using FT/IR620 made by Nippon Bunko) Numbers in parentheses are number of times peaks were observed in IR-RAS measurement of 10 points).
**Coverage: Value computed using equation (8)
***Friction: Value of friction measured by LFM method using Nano-Scope III unit made by Digital Instruments relative to vapor deposited carbon film sample
****External appearance of optical element: External appearance of optical element through 500^{th} pressing in continuous pressing with the same mold.
A: No cracking, clouding, or fogging up to 500^{th} pressing.
B: Fewer than 10 optical elements exhibiting cracking, clouding, or fogging up to 500^{th} pressing
C: Cracking appearing during pressing

TABLE 7
Table of Examples and Comparative Examples

| Item | Example 14 | Example 15 | Example 16 | Example 17 |
|---|---|---|---|---|
| Glass (Tg/Ts) | Phosphate-based | Borosilicate- | Phosphate-based | Phosphate-based glass |
| | glass containing | based glass | glass containing | containing F |
| | alkali metal oxide | containing | alkali metal oxide | (420° C./480° C.) |
| | (480° C./530° C.) | alkali metal | (480° C./530° C.) | |
| | | oxide | | |
| | | (515° C./545° C.) | | |
| Coating solution | Anhydrous | Anhydrous | Anhydrous hexane | Anhydrous hexane |
| | benzene solution | toluene solution | solution of 1 wt % | solution of 0.5 wt % |
| | of 3 wt % | of 0.5 wt % 1- | octatrichlorosilane | dieicosyldimethyl |
| | trichlorovinyl- | decanethiol | (CH₃(CH₂)₁₁SiCl₃) | ammonium bromide |
| | silane | (CH₃(CH₂)₉SH) | | (CH₂(CH₂)₁₉)₂(CH₃)₂NBr) |
| | (CH₂═CH₂SiCl₃) | | | |
| Film forming | Immersion | Immersion | Immersion | Immersion (20° C./180 |
| conditions | (20° C./40 sec) | (20°/120 sec) | (20° C./60 sec) | sec) |
| (Conditions) | | | | |
| Self-assembly* | Good (10/10) | Good (10/10) | Good (10/10) | Good (10/10) |
| Average film | 0.5 nm | 2.6 nm | 1.1 nm | 3.8 nm |
| thickness | | | | |
| Film thickness at | 0.5 nm | 2.6 nm | 1.1 nm | 4.4 nm |
| center | | | | |
| Film thickness at | 0.5 nm | 2.6 nm | 1.1 nm | 3.4 nm |
| periphery | | | | |
| Free surface | 36-38 mJ/m² | 28-32 mJ/m² | 28-32 mJ/m² | 26-28 mJ/m² |
| energy | | | | |
| Coverage** | 95% | 100% | 100% | 100% |
| Composition of | C₂H₄Si— glass | C₁₀H₂₁S— glass | C₁₂H₂₅Si— glass | (CH₂(CH₂)₁₉)₂(CH₃)₂N— |
| film prior to heat | material | material | material | glass material |
| treatment | | | | |
| Heat treatment | 350° C./20 sec | 300° C./120 sec | 300° C./240 sec | 300° C./10 sec |
| Average film | 0.3 nm | 1.8 nm | 0.7 nm | 2.9 nm |
| thickness after | | | | |
| heat treatment | | | | |
| Film thickness in | 0.3 nm | 1.9 nm | 0.7 nm | 3.1 nm |
| center portion | | | | |
| after heat | | | | |
| treatment | | | | |
| Film thickness at | 0.3 nm | 1.5 nm | 0.7 nm | 2.1 nm |
| periphery after | | | | |
| heat treatment | | | | |
| Free surface | 46-48 mJ/m² | 52-59 mJ/m² | 48-51 mJ/m² | 46-48 mJ/m² |
| energy after heat | | | | |
| treatment | | | | |
| Coating rate after | ≧90% | ≧90% | ≧90% | ≧90% |
| heat treatment** | | | | |
| Friction after | 1.0 | 0.8 | 0.8 | 0.8 |
| heat | | | | |
| treatment*** | | | | |
| Film components | C, Si, small | C, S, small | C, Si, small | C, N small amount of H |
| | amount of H | amount of H | amount of H | |
| External | B | A | A | A |
| appearance of | | | | |
| optical | | | | |
| element**** | | | | |

*Determination of self-assembly: Determination of the presence or absence of peaks by IR-RAS measurement (using FT/IR620 made by Nippon Bunko) Numbers in parentheses are number of times peaks were observed in IR-RAS measurement of 10 points).
**Coverage: Value computed using equation (8)
***Friction: Value of friction measured by LFM method using Nano-Scope III unit made by Digital Instruments relative to vapor deposited carbon film sample
****External appearance of optical element: External appearance of optical element through 500^{th} pressing in continuous pressing with the same mold.
A: No cracking, clouding, or fogging up to 500^{th} pressing.
B: Fewer than 10 optical elements exhibiting cracking, clouding, or fogging up to 500^{th} pressing
C: Cracking appearing during pressing

TABLE 8
Table of Examples and comparative Examples

| Item | Example 18 | Example 19 | Example 20 | Comp. Example 4 |
|---|---|---|---|---|
| Glass (Tg/Ts) | Borate-based glass | Borate-based | Phosphate-based | Borate-based glass |
| | containing alkali | glass containing | glass containing F | containing alkali |
| | metal oxide | alkali metal oxide | (420° C./480° C.) | metal oxide |
| | (520° C./560° C.) | (520° C./560° C.) | | (520° C./560° C.) |
| Coating solution | Anhydrous xylene | Anhydrous | Anhydrous benzene | Anhydrous hexane |
| | solution of 0.5 | hexane solution | solution of 20 wt % | solution of 1 wt % |
| | wt % diallyl | of 1 wt % | trichlorovinylsilane | n-octadecyl |
| | disulfide | dipropyl disulfide | (CH₂═CH₂SiCl₃) | trichlorosilane |
| | ((CH₂═CHCH₂S)₂) | ((C₂H₇)₂S)₂) | | (CH₃(CH₂)₁₇SiCl₃) |
| Film forming | Immersion | Immersion | Immersion | Immersion |
| conditions | (20° C./150 sec) | (20° C./40 sec) | (20° C./30 sec) | (20° C./60 sec) |
| (Conditions) | | | | |
| Self-assembly* | Good (10/10) | Good (10/10) | Good (8/10) | Good (10/10) |
| Average film | 1.1 nm | 1.2 nm | 0.3 nm | 4.0 nm |
| thickness | | | | |
| Film thickness at | 1.2 nm | 1.3 nm | 0.2 nm | 4.0 nm |
| center | | | | |
| Film thickness at | 1.0 nm | 1.2 nm | 0.3-0.4 nm | 4.0 nm |
| periphery | | | | |
| Free surface | 28-32 mJ/m² | 23-28 mJ/m² | 38-52 mJ/m² | 25-28 mJ/m² |
| energy | | | | |
| Coverage** | 100% | 0% | 60% | 100% |
| Composition of | C₃H₅S— glass | C₄H₁₄S— glass | C₂H₄Si— glass | C₁₈H₃₇Si— glass |
| film prior to heat | material | material | material | material |
| treatment | | | | |
| Heat treatment | 400° C./30 sec | 500° C./30 sec | 350° C./30 sec | 850° C./30 sec |
| Average film | 0.7 nm | 0.7 nm | ≦0.2 nm | ≦0.2 nm |
| thickness after | | | | |
| heat treatment | | | | |
| Film thickness in | 0.8 nm | 0.9 nm | ≦0.2 nm | ≦0.2 nm |
| center portion after | | | | |
| heat treatment | | | | |
| Film thickness at | 0.4 nm | 0.8 nm | ≦0.2 nm | ≦0.2 nm |
| periphery after | | | | |
| heat treatment | | | | |
| Free surface | 48-55 mJ/m² | 43-51 mJ/m² | 48-59 mJ/m² | 67-72 mJ/m² |
| energy after heat | | | | |
| treatment | | | | |
| Coating rate after | ≧90% | ≧90% | 90% | ≦10% |
| heat treatment** | | | | |
| Friction after heat | 0.8 | 0.9 | 0.7-0.9 | 3.2 |
| treatment*** | | | | |
| Film components | C, S, small amount | C, S, small | C, Si, small amount | Undetected |
| | ofH | amount of H | of H | |
| External | A | B | B | C |
| appearance of | | | | |
| optical | | | | |
| element**** | | | | |

*Determination of self-assembly: Determination of the presence or absence of peaks by IR-RAS measurement (using FT/IR620 made by Nippon Bunko) Numbers in parentheses are number of times peaks were observed in IR-RAS measurement of 10 points).
**Coverage: Value computed using equation (8)
***Friction: Value of friction measured by LFM method using Nano-Scope III unit made by Digital Instruments relative to vapor deposited carbon film sample
****External appearance of optical element: External appearance of optical element through 500^{th} pressing in continuous pressing with the same mold.
A: No cracking, clouding, or fogging up to 500^{th} pressing.
B: Fewer than 10 optical elements exhibiting cracking, clouding, or fogging up to 500^{th} pressing
C: Cracking appearing during pressing

According to the present invention, in the course of press molding glass materials with a pressing mold to manufacture glass articles such as optical elements, the formation of a self-assembled film on the surface of the glass material for molding permits the formation of a surface layer serving as mold separation layer and reaction preventing layer on the surface of the glass material for molding. As a result, it is possible to stably produce glass articles without fusion of mold and glass, clouding, fogging, and/or cracking.

Further, according to the present invention, in the course of press molding glass materials with a pressing mold to manufacture glass articles such as optical elements, the formation of a self-assembled film on the surface of the glass material, or the further heat treatment thereof to provide a carbon-based thin film permits the stable production of glass articles while preventing fusion, clouding, fogging, and cracking during molding.

Still further, it is possible to inhibit fusion of glass to the mold separating film provided on the pressing mold and reduce the frequency of regeneration of the mold separating film when press molding glass materials are provided with this carbon-based film.

The disclosure of the present Specification relates to the subject matter of Japanese Patent Application No. 2002-225598 submitted on Aug. 2, 2002, and the full disclosure thereof is specifically incorporated by reference herein.

What is claimed is:

1. A glass material for molding which is a preformed glass material and has a self-assembled film on the surface thereof.

2. The glass material according to claim 1, wherein the surface of the glass material on which the self-assembled film has been provided exhibits a free surface energy of less than or equal to 60 mJ/m².

3. The glass material according to claim 1, wherein the self-assembled film is comprised of an organic silicon-containing compound, organic sulfur-containing compound, organic fluorine-containing compound, or organic nitrogen-containing compound.

4. The glass material according to claim 1, wherein the self-assembled film is comprised of at least one compound selected from among the group consisting of trialkyl silane compounds, dialkyl silane compounds, alkyl silane compounds, alkyl dimethyl silane compounds, alkane thiol compounds, dialkyl sulfide compounds, dialkyl disulfide compounds, and dimethyl ammonium compounds.

5. A method of manufacturing a glass material for molding comprising a step of immersing a preformed glass material in an organic solution comprising an organic silicon-containing compound, organic sulfur-containing compound, organic fluorine-containing compound, or organic nitrogen-containing compound to obtain a glass material having a self-assembled film.

6. The method of manufacturing according to claim 5, wherein the molecule of the organic silicon-containing compound, organic sulfur-containing compound, organic fluorine-containing compound, or organic nitrogen-containing compound comprises a —Cl group, —H group, or (S—S) group in its molecule.

7. The method of manufacturing a glass material for molding according to claim 5, wherein the organic silicon-containing compound, organic sulfur-containing compound, organic fluorine-containing compound, or organic nitrogen-containing compound is at least one member selected from among the group consisting of chlorotrialkyl silane compounds, dichlorodialkyl silane compounds, trichloroalkyl silane compounds, alkyldimethyl (dimethylamino) silane compounds, alkanethiol compounds, dialkylsulfide compounds, dialkyldisulfide compounds, and dimethylammonium compounds.

8. The method of manufacturing according to claim 5, wherein concentration of the organic compound in the organic solution is 0.01 to 10 weight percent.

9. A method of manufacturing a glass material for molding characterized in that a glass material which is a preformed glass material and has a self-assembled film on the surface thereof, or a glass material which has been obtained by a method of manufacturing a glass material for molding comprising a step of immersing a preformed glass material in an organic solution comprising an organic silicon-containing compound, organic sulfur-containing compound, organic fluorine-containing compound, or organic nitrogen-containing compound to obtain a glass material having a self-assembled film is heat treated in a non-oxidizing atmosphere to thermally decompose the self-assembled film on the glass material.

10. The method of manufacturing according to claim 9, wherein temperature of the heat treatment is greater than or equal to 200° C. and less than or equal to 800° C.

11. The method of manufacturing a glass material for molding according to claim 9, wherein a free surface energy of the surface of the glass material obtained by the heat treatment is less than or equal to 70 mJ/m².

12. A method of manufacturing a glass article comprising steps of heat softening a glass material which is a preformed glass material and has a self-assembled film on the surface thereof, or a glass material which has been obtained by a method of manufacturing a glass material for molding in which c a preformed glass material is immersed in an organic solution comprising an organic silicon-containing compound, organic sulfur-containing compound, organic fluorine-containing compound, or organic nitrogen-containing compound to obtain a glass material having a self-assembled film; and press molding the glass material with a pressing mold.
